(19) United States
(12) Patent Application Publication
(10) Pub. No.: US 2004/0206006 A1
(43) Pub. Date: Oct. 21, 2004

(54) Safety device limiting closure of a gap

(76) Inventors: Neil Francis De La Coeur, Albert Park (AU); Paul Anthony Mizzi, Kew (AU)

Correspondence Address: Andrus Sceales Starke & Sawall, Suite 1100, 100 East Wisconsin Avenue, Milwaukee, WI, 53202-4178, US

(21) Appl. No.: 10/486,264

(22) PCT Filed: Aug. 9, 2002
(86) PCT No.: PCT/AU02/01071

(30) Foreign Application Priority Data
Aug. 9, 2001 (AU) PR6911

(51) Int. Cl. E06B 7/16

(52) U.S. Cl. 49/383

(57) ABSTRACT

The invention provides a safety device (10) for limiting closure of a gap (26) between two relatively movable members (12,14) when an obstruction (44) protrudes into gap (26) during closure. The safety device (10) has a sensor (36) to detect obstruction (44) in gap (26). A jamming member (32) is adapted to be operative to enter gap (26) when sensor (36) has detected obstruction (44) during closure to limit closure of gap (26) between the two relatively movable members (12,14).

This invention relates to a safety device, and relates particularly, though not exclusively to a safety device for preventing the crushing of fingers from closing doors.

Safety devices for preventing injuries related to door jambs are well known. U.S. Pat. No. 4,290,233, by Kawneer Company, Inc. (the ‘Kawneer’ patent), discloses a safety door entrance device which includes a door mounted for swinging movement on hinges connected to a door jamb and a protector for continuously bridging a gap formed between the door heel and adjacent jamb as the door swings open and closed. This protector prevents a person's fingers, toes or other objects from accidentally being inserted in the gap and being subject to damage when the door swings closed.

U.S. Pat. No. 5,359,812, by Charles D. Mayfield (the ‘Mayfield’ patent), discloses a safety device which is described as a slidable door guard for temporarily bridging or covering the opening formed between the door heel and adjacent doorjamb. This device essentially consists of a first engaging, or male member, and a second receiving, or female member, having a pocket therein to slidingly hold at least a portion of the male member therein as the door is opened and closed, to prevent children from accidentally crushing their fingers as the door is closed.

U.S. Pat. No. 5,509,235, by Radhakrishnan Chander (the ‘Chander’ patent), discloses a safety device for hinged doors, which includes a spring loaded wedge shaped stopper means, connected to a bracket that is attached to a door or door jamb near its hinged side. When the spring is not loaded, the stopper means is positioned naturally in an obtrusive manner in the front face gap near the hinge side created by the opening and closing of the hinged door, thereby preventing a partially opened door from being shut by small children who can accidentally insert their fingers or other body parts into the gap. At any stage that an adult so desires to close the door they can do so by rotating the stopper means, about its hinge pin connecting it to the bracket, against the restoring spring, away from the gap, which provides for normal closure of the door.

U.S. Pat. No. 5,581,844, by Robert Raheb (the ‘Raheb’ patent), discloses a safety device which is essentially a modified door hinge that has provisions for the securing of a removable block member against a leaf of the hinge on a door jamb. When in place, this block member prevents the door from completely closing, therefore preventing fingers from getting caught and damaged between an edge of the door and the door jamb. This block member continues to prevent the door from closing until such time that it is removed and as such will not prevent the door from closing again until it is placed back into position.

In each of the patents described above the safety devices disclosed are effective in reducing the chance of an injury associated with jambs of doors. However each device has its own drawbacks. In the case of the Kawneer and Mayfield patents, these safety devices are protective guards which need to be permanently in place if they are to protect a child from jamming their fingers. These devices restrict access to hinges requiring attention and restrict door movement due to added friction or wear on the sliding guard. The Chander and Raheb patents describe devices which manually need to be placed into position and permanently restrict the door from closing. These devices are frustrating as an adult must remove, or re-position the stopper means, before the door can be closed. The Chander and Raheb devices will not prevent an accidental injury if they are not in place. If an adult forgets to put the device in place an injury to a child can occur.

An object of the present invention is to provide an improved method and/or device for preventing jamming and/or injury of fingers, toes or other objects between doors/windows and jambs.

A further object of the present invention is to provide a method and/or device which allows a door or window to open and close in a normal manner, whilst there is no obstruction in the closing gap formed between the adjacent surfaces of the door or window and the jamb.

With these objects in view the present invention in one aspect provides a safety device for limiting closure of a gap between two relatively movable members when an obstruction protrudes into said gap during closure, said safety device including a sensor to detect said obstruction in said gap, and a jamming member adapted to be operative to enter said gap when said sensor has detected said obstruction during said closure to limit closure of said gap between said two relatively movable members.

Preferably said jamming member is a plunger member located in one of said relatively movable members, said plunger member adapted to be movable from a first position inside said one of said relatively movable members to a second position where said plunger member extends from said one of said relatively movable members to abut the other of said relatively movable members to limit closure of said gap between said relatively movable members. In a preferred embodiment said plunger member is a solenoid or is resiliently biased. It is preferred that said sensor is a heat or movement detector.

In a practical embodiment one of said relatively movable members is a door or window and the other of said relatively movable members is a door or window jamb. The safety device may be integrated into a hinge with the plunger emerging from one of the leaves of said hinge and the other leaf of the hinge acting as a striker plate for said plunger.

In yet a further preferred embodiment said safety device may include a reflector means, positioned at any suitable location, said sensor being a passive infrared (PIR) device, whereby said PIR device senses an obstruction if its emitted beam between said PIR device and said reflector means is breached.

In a further aspect of the invention there is provided a method for limiting closure of a gap between two relatively movable members when an obstruction protrudes into said gap during closure, said method including the steps of monitoring said gap for said obstruction in said gap by a sensor, and inserting a jamming member into said gap when said sensor has detected said obstruction during said closure to limit closure of said gap between said two relatively movable members.

In order that the invention may be more readily understood and put into practical effect, reference will now be made to the accompanying drawings, in which:—

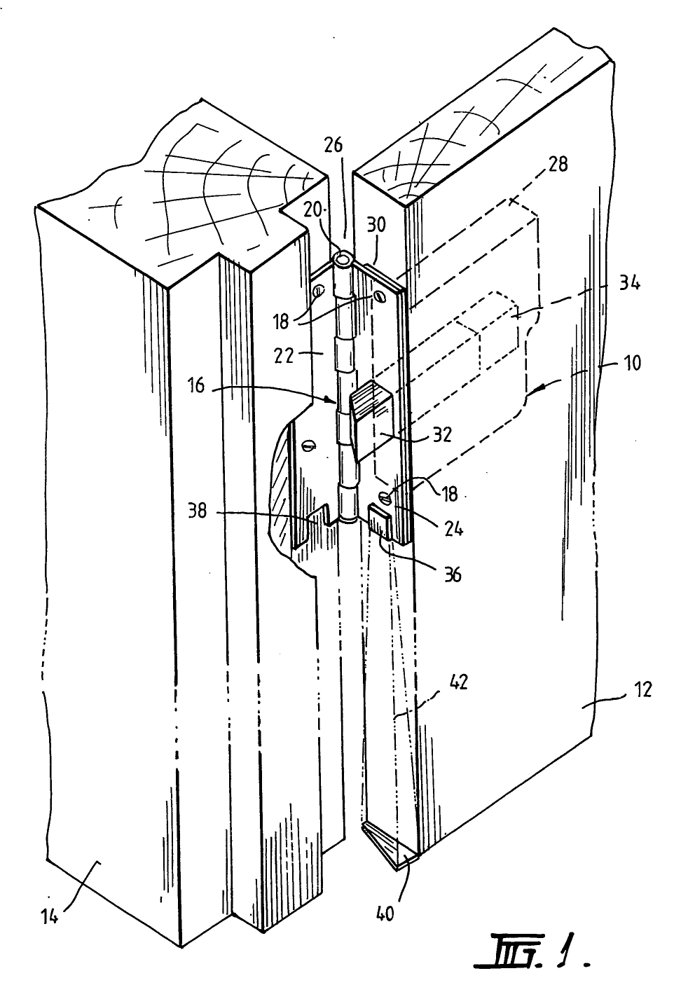

FIG. 1 is a perspective view of a door and door jamb fitted with a safety device made in accordance with a first preferred embodiment of the present invention;

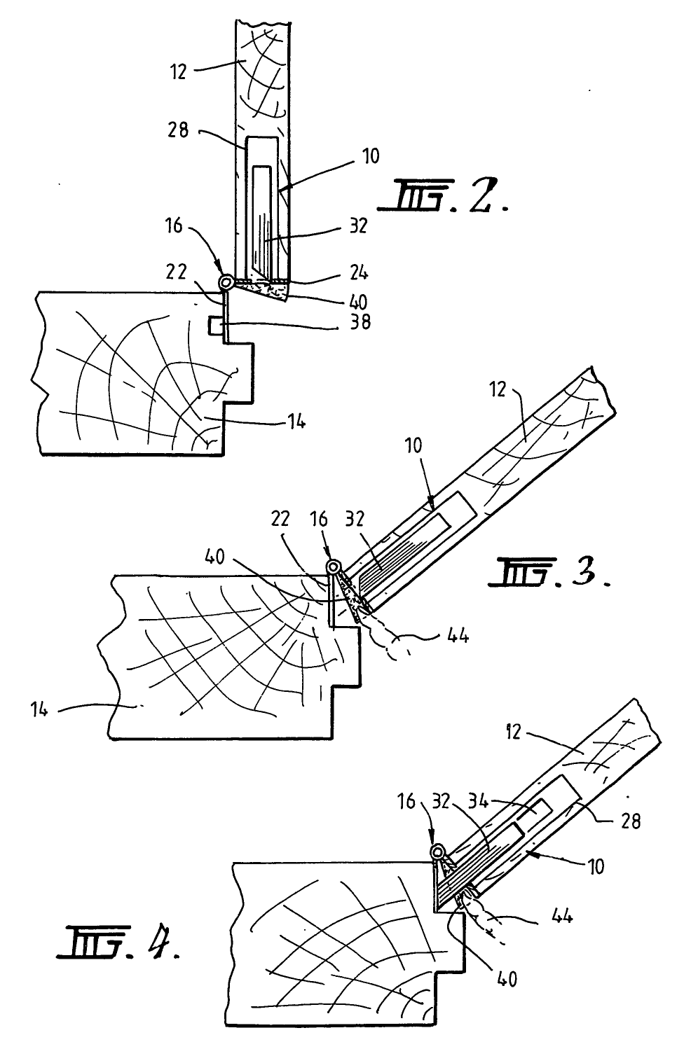

FIG. 2 is a cross-sectional view of the door and door jamb of FIG. 1, shown with the door open;

FIG. 3 is a similar view to that of FIG. 2, showing the door closing with a finger in the gap between the door and the door jamb;

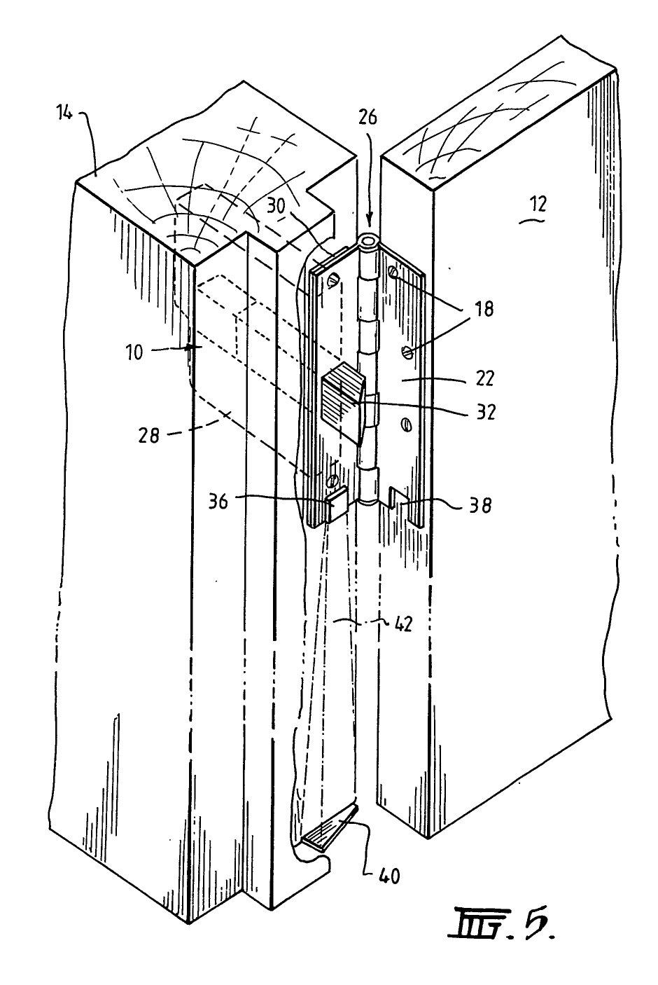

FIG. 4 is a similar view to that of FIG. 2, showing the safety device activated; and

FIG. 5 is a perspective view of a door and door jamb fitted with a safety device made in accordance with a second preferred embodiment of the present invention.

In FIGS. 1 to 4 there is shown a door 12 mounted for swinging movement on a door jamb 14 using a hinge 16. Hinge 16 has a pair of leaves 22,24 which are fastened to door jamb 14 and door 12 respectively by screws 18. A hinge pin 20 joins leaves 22,24 together and allows door 12 to pivot around door jamb 14. The mounting of door 12 to door jamb 14 creates a gap 26 formed between adjacent surfaces of door 12 and doorjamb 14, when the door is opened.

A safety device 10 includes a housing 28 which is fitted inside door 12. A mounting plate 30 of housing 28 is secured to door 12 in abutment with hinge leaf 24. Housed within the housing 28 is a plunger 32, which is moveable from inside housing 28 to a position where a section thereof protrudes from housing 28 through corresponding openings in both mounting plate 30 and hinge leaf 24, as shown in FIG. 1. Plunger 32 is preferably part of a solenoid or a spring loaded throw-bolt held by a solenoid, but can be any suitable device which can be electrically activated directly, or indirectly. Plunger 32 is normally held in its retracted state. Once plunger 32 has been released it will not retract unless a separate action is undertaken, for example, mechanical or electrical release.

A sensor 36 is mounted on hinge leaf 24 and co-operates with a complementary shaped recess 38 formed in hinge leaf 22. Sensor 36 is typically a passive infrared (PIR) device, but may be any other suitable sensor which detects movement or changes in heat. Sensor 36 detects the presence of an obstruction within gap 26. A reflector 40 is positioned at the bottom of door 12 to reflect the PIR beam 42 emitted from sensor 36. Sensor 36 co-operates with a control means (not shown) connected to a power supply means (not shown) which controls operation of plunger 32.

The operation of safety device 10 will now be described. In FIGS. 1 and 2 door 12 is shown open with no obstruction within gap 26 formed between door 12 and adjacent doorjamb 14. Hinge 16 with sensor 36 is fitted as the top most hinge on the door to ensure protection for persons of all heights. Plunger 32 is retracted as shown in FIG. 2 as no obstruction in the path of beam 42 is detected by sensor 36. Control means will hold continue to hold plunger 32 in its retracted state. If no obstruction is detected then door 12 can be fully closed and sensor 36 will be located in recess 38. FIG. 3 shows an obstruction 44, typically a child's finger located in gap 26. As door 12 swings closed in the direction of arrow a, beam 42 is broken by finger 44 between sensor 36 and reflector 40. Sensor 36 signals control means (not shown) to release plunger 32 from inside housing 28. Plunger 32 partially protrudes out of housing 28 and will abut hinge leaf 22 to restrict any further closing of door 12 as shown in FIG. 4. As the length of the protruding plunger is wider than a finger, finger 44 cannot be crushed between door 12 and adjacent jamb 14.

Plunger 32 will remain in its released state until reset. The resetting may be done in any number of ways. If plunger 32 is locked in place mechanically, plunger 32 may need to be pushed up and over a notch and back into the housing 28 until it locks into a reset position. If plunger 32 is part of a solenoid, resetting could be achieved by a reset switch (not shown). It may also be desirable for the control means to automatically withdraw plunger 32 upon sensor 36 detecting removal of finger 44.

FIG. 5 shows a second variation of the embodiment shown in FIGS. 1 to 4. In order to avoid duplication of description the same reference numerals used in FIGS. 1 to 4 have been reproduced to denote similar elements. The construction and operation safety device 10 in this embodiment is identical to that shown in FIGS. 1 to 4. An advantage of mounting housing 28 in door jamb 14, instead of door 12, is the ease of supplying electric wiring (not shown) to safety device 10. Power could be hard-wired directly to safety device 10 through the wall abutting doorjamb 14.

Safety device 10 may also include an additional sensor (not shown) strategically located on, or around door 12 or doorjamb 14. This additional sensor can communicate with the control means to also activate plunger 32. If the additional sensor is fitted to the non-hinged side of door 12 it can prevent finger injuries between the opposite door jamb and the non-hinged side of door 12. Another option that can be installed is a device for detecting the position of the door 12 in relation to its jamb 14. This device could be used to detect whether door 12 is opened far enough for a finger 44 to be inserted into gap. The calculation of this distance, or crucial angle, upon which the door 12 becomes a potential danger could be useful for controlling when sensor 36 becomes active and will reduce power consumption.

Although the preferred embodiments have been described with reference to integration with hinge 16, it is apparent that it may be independent thereof. The preferred embodiment has been described with reference to a door but it can also be applied to any pivoting or sliding devices e.g. hinged windows, folding doors, sliding doors/windows, drawers, motor vehicle doors, motor vehicle bonnets, etc.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

1. A safety device for limiting closure of a gap between two relatively movable members when an obstruction protrudes into said gap during closure, said safety device including a sensor to detect said obstruction in said gap, and a jamming member adapted to be operative to enter said gap when said sensor has detected said obstruction during said closure to limit closure of said gap between said two relatively movable members.

2. The safety device of claim 1, wherein said jamming member is a plunger member located in one of said relatively movable members, said plunger member adapted to be movable from a first position inside said one of said relatively movable members to a second position where said plunger member extends from said one of said relatively movable members to abut the other of said relatively movable members to limit closure of said gap between said relatively movable members.

3. The safety device of claim 2, wherein said plunger is a solenoid or is resiliently biased.

4. The safety device of claim 1, wherein said sensor is a heat or movement detector.

5. The safety device of claim 1, wherein one of said relatively movable members is a door or window and the other of said relatively movable members is a door or window jamb.

6. The safety device of claim 1, wherein said safety device is integrated into a hinge with the jamming member emerging from one of the leaves of said hinge and the other leaf of the hinge acting as a striker plate for said jamming member.

7. The safety device of claim 1, further including a reflector means, positioned at any suitable location, said sensor being a passive infrared (PIR) device, whereby said PIR device senses an obstruction if its emitted beam between said PIR device and said reflector means is breached.

8. The safety device as claimed in claim 1, wherein said jamming member is adapted to be withdrawn from said gap after said obstruction has been cleared.

9. The safety device of claim 3, wherein said plunger is adapted to be withdrawn from said gap after said obstruction has been cleared.

10. A method for limiting closure of a gap between two relatively movable members when an obstruction protrudes into said gap during closure, said method including the steps of monitoring said gap for said obstruction in said gap by a sensor, and inserting a jamming member into said gap when said sensor has detected said obstruction during said closure to limit closure of said gap between said two relatively movable members.

11. The method of claim 10, wherein said jamming member is adapted to be withdrawn from said gap after said obstruction has been cleared.

12. The method of claim 10, wherein said jamming member is a plunger member located in one of said relatively movable members, said plunger member being movable from a first position inside said one of said relatively movable members to a second position where said plunger member extends from said one of said relatively movable members to abut the other of said relatively movable members to limit closure of said gap between said relatively movable members.

13. The method of claim 12, wherein said plunger member is a solenoid or is resiliently biased.

14. The safety device of claim 10, wherein said sensor is a heat or movement detector.

15. The safety device of claim 10, wherein one of said relatively movable members is a door or window and the other of said relatively movable members is a door or window jamb.

16. (cancelled)
